(19) United States
(12) Patent Application Publication
(10) Pub. No.: US 2006/0150153 A1
(43) Pub. Date: Jul. 6, 2006

(54) Digital object verification method

(76) Inventor: Micah Altman, Somerville, MA (US)

Correspondence Address: Micah Altman, 65 Putnam Rd, Somerville, MA, 02145, US

(21) Appl. No.: 11/294,661

(22) Filed: Dec. 3, 2005

Related U.S. Application Data
(60) Provisional application No. 60/633,403, filed on Dec. 4, 2004.

(51) Int. Cl. G06F 9/44

(52) U.S. Cl. 717/116; 717/108; 717/104

(57) ABSTRACT

A method for identifying the approximate semantic content of digital objects is disclosed. Pursuant to the creation of a digital object, an approximation algorithm is used to compute the approximated semantic content of that object. This approximated content is then put into a normalized form. A hash function is used to compute a unique fingerprint for the resulting normalized, approximated object. This fingerprint is stored along with the object. The same approximation, normalization, and fingerprinting processes are used to generate a fingerprint for the digital object alleged to be semantically identical to the previous object. A match indicates that the alleged object and the previous object are approximately semantically identical. This verification method can be used to validate that a digital object has not been semantically altered, despite restructuring or reformatting of the object.

### CROSS-REFERENCE TO RELATED APPLICATIONS

This application claims the benefit of PPA Ser. Nr. 60/633,403, filed 2005 Dec. 4 by the present inventors.

### SEQUENCE LISTING OR PROGRAM

This application is accompanied by an appendix on CD containing source code sufficient to implement the method. This has been submitted in duplicate on two identical CD-ROM's with all files in ASCII format. The CD-ROM is in IBM-PC format, with files stored in ASCII. The files contain source code listings in the C++ programming language, and will compile and run under the MS-Windows, Macintosh, and Linux operating systems.

The files on the CD ROM are contained in two directories entitled: “UNF\src” and“standalone”. These directories are comprised of the following files:

1. UNF\src\unf.C: C++-language source code that implements the normalized approximate fingerprint method for numeric and character vectors hash algorithm. 15620 Bytes. Created Dec. 3, 2005. ASCII text with Unix-style end-of-line characters.

2. UNF\src\unf.h: C++-language header file that contains definitions for unf.C. 1353 Bytes. Created Dec. 3, 2005. ASCII text with Unix-style end-of-line characters.

3. UNF\src\md5.c: C-language source code that implements the MD5 hash algorithm, used by unf.C. 12438 Bytes. Created Dec. 3, 2005. ASCII text with Unix-style end-of-line characters.

4. UNF\src\md5.h: C-language header file that contains definitions for m5.C. 3396 Bytes. Created Dec. 3, 2005. ASCII text with Unix-style end-of-line characters

5. standalone\unfvector.C: C++-language source code that implements a command line user interface, unfvector, to the unf.C code library. 3516 Bytes. Created Dec. 3, 2005. ASCII text with Unix-style end-of-line characters.

6. standalone\unfvector.txt: instructions for using the command-line interface, unfvector. 4023 Bytes. Created Dec. 3, 2005. ASCII text with Unix-style end-of-line characters.

7. standalone\Makefile: a configuration file in the Make syntax to aid in compilation of unfvector. 832 Bytes. Created Dec. 3, 2005. ASCII text with Unix-style end-of-line characters.

### BACKGROUND OF THE INVENTION

1. Field of Invention

This invention generally relates to digital objects, specifically to verifying the content of a digital object.

2. Prior Art

With the increasing popularity of digital storage environments, there has been a corresponding increase in the demand for works to be issued in digital form. And there has been a corresponding increase in the variety of forms in which a work may be embodied. A central problem in digital archiving has been determine when two or more objects have approximately the same semantic content, when both the format and fidelity of both are different. A separate, but related problem is how to determine whether a particular software program used to present such semantic content from a file to a user has correctly interpreted that content.

For example, a particular performance of a song may be digitized and disseminated in dozens of different file formats. Each of these different formats is recognizable to humans as representing the same performance of the same song, but differs in technical details such as the underlying encoding, file size, sampling frequency, sampling bit depth, compression algorithm, and many other criteria. The file formats and the compression methods used in them may also cause changes the precision, fidelity, accuracy, or level of detail of that object. Such changes are might be entirely invisible to the user. And even where such changes resulted in a some perceptible loss of quality, a person would continue to recognize the resulting object as (approximately) semantically identical.

In other words, the bit-level structure and content of two such files may be completely different, and yet the “semantic content” (that content which is meaningful to a person using that object) is the same. However, there is no standardized method for verifying automatically that the semantic content of two such objects, is, in fact, the same. Nor is there a way of automatically verifying that a particular software program correctly and consistently interprets the semantic content of a particular object across a variety of formats.

These problems apply, as well, to digital objects representing other types of content, for example: textual objects, such as a particular newspaper article, numeric object such as a dataset or database, and objects representing an image or a segment of video. For each of these types of objects, content that is approximately the same semantically may be represented in a wide variety of formats, each of which differs in terms of syntax, structure, and, in some cases, fidelity.

As a result, methods have been developed to represent objects in standard formats. Normalization or “normal forms” have long been used in mathematics and algorithms to transform a digital object into a standardized representation. This process has been applied to digital objects under the heading “canonicalization” (see Clifford Lynch, 1999, “Canonicalization: A Fundamental Tool to Facilitate Preservation and Management of Digital Information”, D-Lib Magazine 9(5). ). Normalization of objects alone, has not been used to establish the identify of multiple object across reformatting, and would be generally insufficient to do so whenever such reformatting of an object changes the precision, fidelity, accuracy, or level of detail of that object in even a trivial way. This is a well known issue for video and audio formats, in reformatting complex text documents, and surprisingly occurs commonly even in reformatting purely numerical databases.

Methods and algorithms for have been developed that attempt to verify when one object is a derivative of another object that is manifested in a different format. These methods operate through insertion or alteration of data in unused of unnoticed portions of the object to form a digital watermark. (See, Barton, James M. “Method and apparatus for embedding authentication information within digital data”, U.S. Pat. No. 5,646,997, issued Jul. 8, 1997). Subsequent research into digital watermarks have produced algorithms that are designed to be robust to lossy transformations of the object. And hence some types of image objects can be identified as a derivative of another even when the derivative is manifested in a different file format. (For a survey see: P. Meerwald, and A. Uhl, 2001. “A Survey of Wavelet-Domain Watermarking Algorithms” in Proceedings of SPIE, Electronic Imaging, Security and Watermarking of Multimedia Contents III, vol 4314, pages 506-516.)

Watermarks have significant shortcomings when used to establish the semantic equivalence of two digital objects. Watermarking algorithms cannot be used to establish that two independently created objects are semantically equivalent, since these will not share the same watermark. Conversely, two objects could have identical watermark information added, but contain completely different semantic content. Nor can watermarks be used to verify that a derivative is identical to a watermarked digital object, if the derivative was created from the original digital object before the watermark was applied to that original digital object. Furthermore, watermarks are not practical for some objects, such as numeric data and source code files, where the alterations created by the watermarking process tend to alter the semantic content of the digital object.

Another technique in use is to add authentication information to an analogue form of the object, in a location that does not affect the original, and to transmit and use that analogue form in place of the digital form. This is not applicable for the many applications that require digital objects. Nor can it be used to verify that a derivative object is identical to a digital object, if the derivative was created from the original digital object. Nor can it be used to establish the semantic equivalence of two digital objects constructed independently.

In addition to watermarking algorithms, there are also algorithms that may be used to verify that a digital object has not been altered in any way. These are typically known as “cryptographic hash functions”. An example of such an algorithm is the MD5 algorithm (Rivest, R. 1992 “MD5 Digest Algorithm”, RFC 1321, pages 1-21.). A cryptographic hash function takes a sequence of bytes of arbitrary length and produces as output a short “fingerprint” or “message digest” of the input. These algorithms are designed such that any accidental alteration of the sequence of bytes will produce a different fingerprint, and such that it is computational difficult to discover alternate sequences of bytes that produce the same fingerprint. Thus cryptographic hashes are used to verify that a digital object has not been altered since the generation of the fingerprint.

In contrast, cryptographic hash functions can be used to establish that independent objects are identical, and do not require alteration of the objects, but cannot be used to determine whether two digital objects in different formats are semantically/intellectually identical or approximately identical. Since any reduction in quality of the object, or change in format of the object will result in the object being manifested as a different sequence of bytes, any such changes will cause the cryptographic hash of the object to change.

### BRIEF SUMMARY OF THE INVENTION

In accordance with the present invention, there is provided a verification method and system for verification of digital objects which addresses deficiencies of the prior art.

The verification system, according to a first aspect of the present invention, includes the steps of (1) reading the digital object data; (2) producing an approximation of the semantic content of that data using either a generalized approximation algorithm or a type-specific, parameterized approximation algorithm; (3) producing a normalized form of this approximate representation, using a type-specific normalization algorithm; (4) creating a unique digital fingerprint of this object, by applying a cryptographic digest algorithm to the normalized form of the approximated representation.

In accordance with a second aspect of the present invention, to determine whether two objects are semantically identical, the four steps above are performed for each object and the resulting fingerprint compared. The two objects are determined to be semantically identical if and only if the resulting fingerprints are identical.

In accordance with a third aspect of the present invention, to verify that a software program is correctly interpreting an object, the software program first reads in the file and transforms it into internal data using its own representation, it then uses a standardized application programmers interface (api) to provides this internal data to a function that performs the second method above. This ensures that the programs own internal representation of the object is in fact correct, and thus verifies that the object has been interpreted properly.

### OBJECTS AND ADVANTAGES

It is therefore an object of the invention to provide a method for verifying the approximate semantic equivalence of two digital objects.

It is another object of the invention to provide a method for verifying the approximate semantic equivalence of two digital objects that is robust to reformatting of the digital objects.

It is another object of the invention to provide a method for verifying the approximate semantic equivalence of two digital objects that are created independently, where one is not a direct digital copy or derivative of the other.

It is another object of the invention to provide a method for verifying the approximate semantic equivalence of two digital objects that functions even when the object has been subject to moderate loss of fidelity, precision, and accuracy.

It is another object of the invention to provide a method for verifying the approximate semantic equivalence of two digital objects that does not require alteration of the original object.

It is another object of the invention to provide a method for verifying that a specified software program has correctly interpreted the approximate semantic content of a digital object.

Further and still other objects of the invention will become apparent from the detailed description given hereinafter. However, it should be understood that the detailed description and specific examples, while indicating preferred embodiments of the invention, are given by way of illustration only, since various changes and modification within the spirit and scope of the invention will be apparent to those skilled in the art from this detailed description.

### BRIEF DESCRIPTION OF THE SEVERAL VIEWS OF THE DRAWINGS

A complete understanding of the present invention may be obtained by reference to the accompanying drawings, when considered in conjunction with the subsequent, detailed description, in which:

FIG. 1 is a flowchart showing the operation of the digital object verification method according to an embodiment;

FIG. 2 is a diagram showing a case of two different data matrices as an example of digital objects used as input;

FIG. 3 is a diagram showing normalized fingerprints represented in human readable, self-documenting form;

FIG. 4 is a flowchart showing the operation of the digital object verification method using one set of type-specific normalization and approximation methods;

FIG. 5 is a is a flowchart showing the operation of the fingerprint comparison method according to an embodiment;

FIG. 6 is a flowchart showing the operation of the digital object comparison method according to an embodiment;

FIG. 7 is a block diagram showing a fingerprint generation and verification apparatus according to an embodiment; and

FIG. 8 is a block diagram showing the software verification method according to an embodiment.

For purposes of clarity and brevity, like elements and components will bear the same designations and numbering throughout the FIGURES.

### DETAILED DESCRIPTION OF THE INVENTION

[Description of First Embodiment]

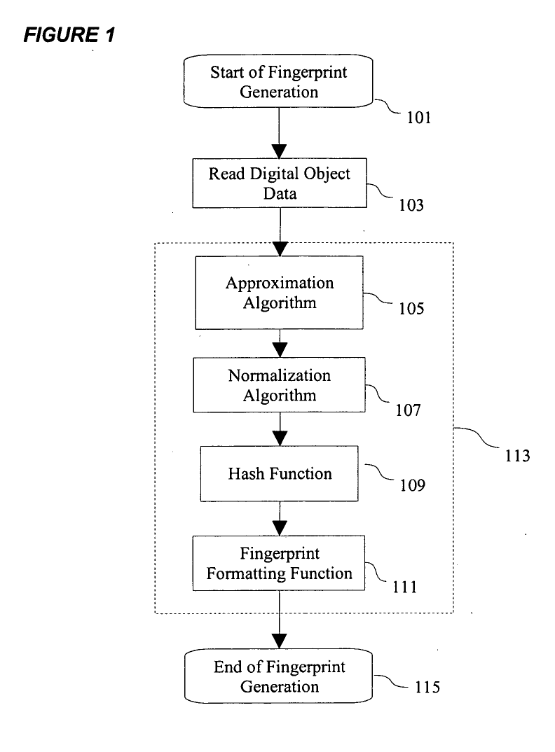

The first embodiment of the present invention will be described with reference to the drawing. FIG. 1 is a flowchart showing the operation of the digital object verification method according to the present embodiment.

As shown in the figure, the fingerprint generation process is comprised of reading the digital object 103, a semantic approximation algorithm 105, which generates a deterministic approximation of the semantic content of the object; a sequential normalization algorithm 107, which converts the approximated content into a standard normal form byte-sequence; and a hash function 109, which generates a digital fingerprint using the normalized byte sequence. The fingerprint is then formatted in a self-documenting format 111. Steps 105, 107, 109, and 111 may be grouped together as shown in 113 to form a code library for use in other applications.

In one variation, a cryptographic hash function or message digest is used as the hash function 111, providing increased security.

In second variation a parameterizable approximation process is used, providing multiple levels of quality of approximation. This parameterizable approximation process, A( ), accepts as input a digital object, O, of specified type, and an approximation-level parameter, k. A( ) should satisfy two these conditions:

Condition 1. For some measure of semantic distance, d, if k>k′ then d(O,A(O,k))<=d(O,A(O,k′)).

Condition 2. if k >=k′ then A(A(O,k),k′)=A(O,k′)

Examples of approximation procedures that satisfy these conditions include: rounding numeric values to a given number of significant digits; decimation to a given level; spatial or frequency downsampling to a given level. (IEEE. 1979. Programs for Digital Signal Processing. IEEE Press. New York: John Wiley & Sons, 1979; Kevin J. Renze, James H. Oliver, 1996, “Generalized Unstructured Decimation”, IEEE Computer Graphics and Applications, November 1996.)

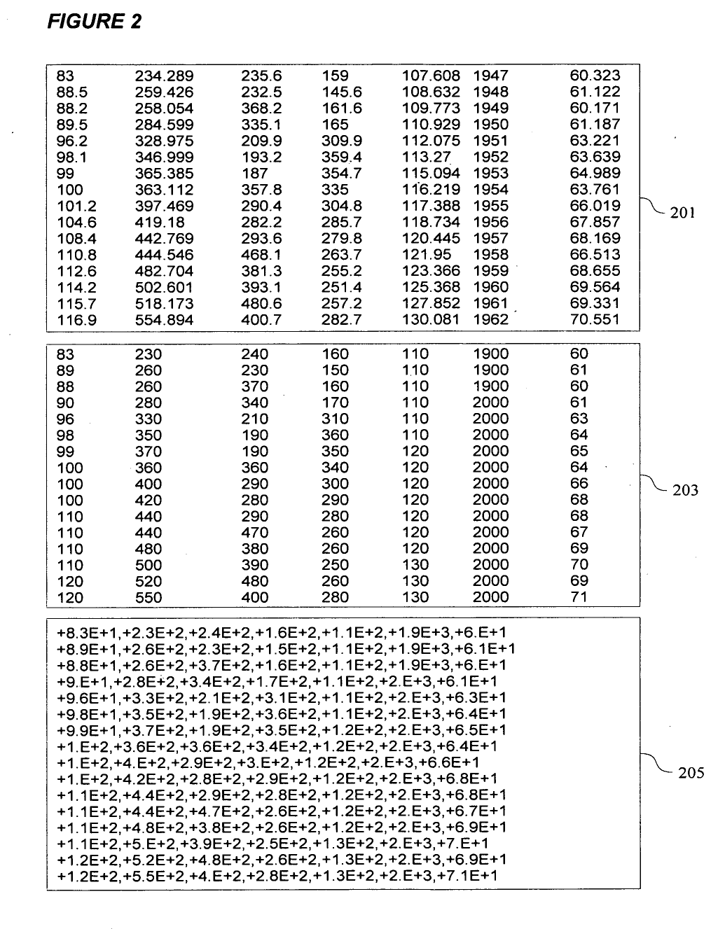

FIG. 2 is a diagram showing a case of two different data matrices as an example of input digital objects. This shows an application of semantic approximation, using rounding to a given number of significant digits.

As shown in the figure, the input objects differ in terms of formatting and numeric precision, but the first digital object 201 represent the same data matrix as the second digital object 203, when rounded to two significant digits. Approximation needs to be applied to produce semantically equivalent matrices; and normalization, as shown in 205, needs to be applied to ensure that the resulting approximate matrices will be represented by identical sequences of bytes, and thus produce identical digital fingerprints using the procedure outlined in FIG. 1.

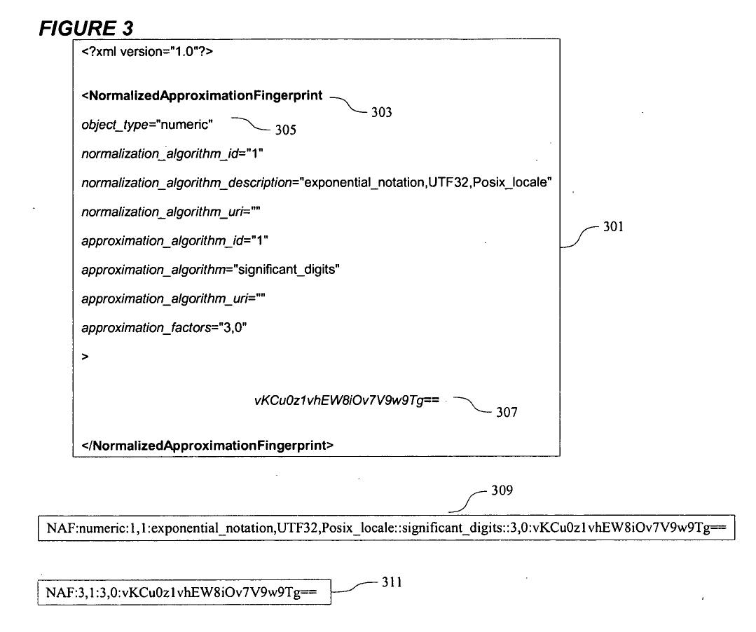

FIG. 3 is a diagram showing normalized fingerprints represented in human readable, self-documenting form; The fingerprint is shown as formatted by the formatting function 111 and represented in a self-documenting XML form 301, which comprises an opening tag indicating the start of the fingerprint 303; a set of attributes documenting the approximation and normalization algorithms used, a reference to their implementations as a UFI, and any parameters used 305; and element text containing the fingerprint in base 64 encoded form 307. The fingerprint, containing the same attributes and element, can also be produced in a more compact form 309, or in an abbreviated form 311.

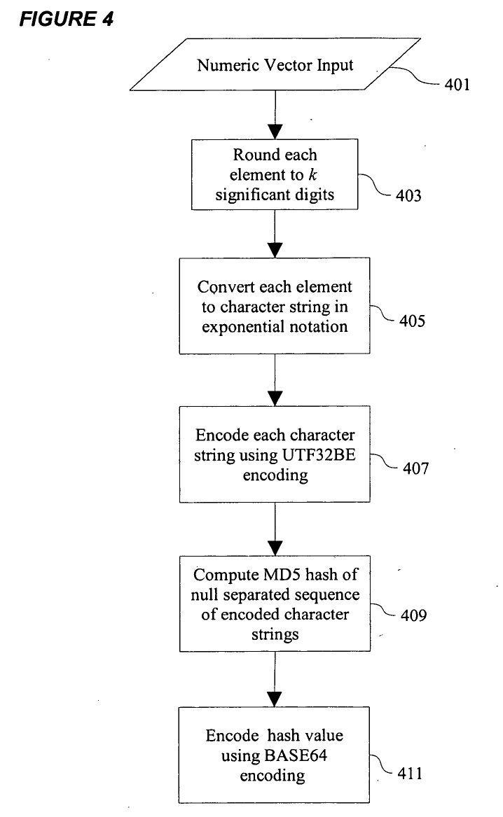

FIG. 4 is a flowchart showing the operation of the digital object verification method using one set of type-specific normalization and approximation methods. The method shown is appropriate for digital objects that represent a sequence of numbers, such as a object representing a numeric vector or database column. As shown in the figure, the type-specific approximation method operates on a numeric vector input 401 and is comprised of the following step 403 in which each element of the numeric vector 401 is rounded to k significant digits. As shown in the figure, the type-specific normalization method is comprised of the following steps: A conversion step 405 in which each number in the approximated sequence produced in 403 is converted to a character representation in exponential notation in which non-informational zeros are discarded, such that numbers are represented as a concatenation of a numeric sign character, a single leading digit, a decimal point, up to k-1 digits following the decimal point and omitting trailing zeros, the letter ‘E’, the sign of the exponent, and the digits of the exponent omitting leading zeros (e.g., using this representation, the number −3.14159 is represented as the string “−3.14159E+” and the number 300 is be represented as the string “3.E+2”) and in which IEEE floating point numeric special values are represented using their upper-case printable equivalents; a third encoding step 407 in which each character string is encoded in the UTF32BE Unicode encoding; a fourth encoding step 409 in which an MD5 hash is computed, treating the vector of character strings produced in 407 as a single sequence, separated with null bytes; a fifth encoding step 411 in which hash produced in 409 is encoded using BASE64 encoding for printing.

[Description of Second Embodiment]

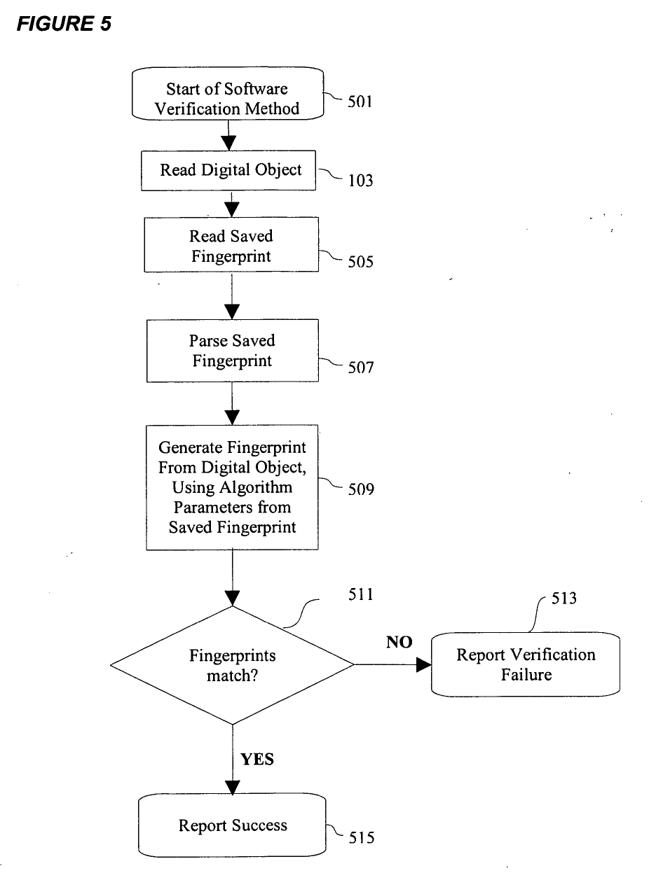

The second embodiment of the present invention will be described with reference to the drawing. FIG. 5 is a flowchart showing the operation of the fingerprint verification system according to the present embodiment.

FIG. 5 is a flowchart showing the operation of the fingerprint verification method according to an embodiment. As shown in the figure, the fingerprint verification method is comprised of the following steps: reading a digital object 103, reading a previously stored fingerprint 501 generated from the original object; reading a digital object alleged to be the same as the original object 503; parsing the saved fingerprint 507, generating a new fingerprint from the digital object using the parameters from the saved fingerprint 509, checking that the two match 511, and reporting either failure 513 or success 515.

[Third Embodiment]

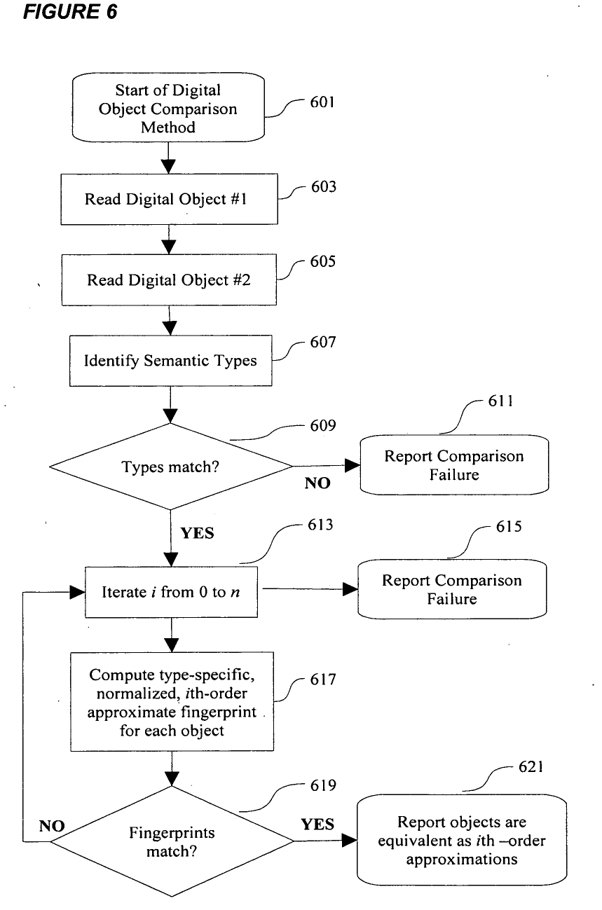

The third embodiment of the present invention will be described-with reference to the drawing. FIG. 6 is a flowchart showing the operation of the fingerprint comparison method according to the present embodiment.

FIG. 6 is a flowchart showing the operation of the fingerprint comparison method according to an embodiment. As shown in the figure, the fingerprint generation method is comprised of a target data acquisition step where the content of two digital objects is acquired 603, 6-5; a type-checking step 607 with a determination as to whether types match 609; a report of failure if no match 611; and an iterative fingerprint generation 613, where the fingerprint generation method shown in FIG. 1 above is used with decreasingly accurate approximations 617 to determine whether fingerprints match at any level of approximation 619; leading to a report of failure 615 or success 621.

[Fourth Embodiment]

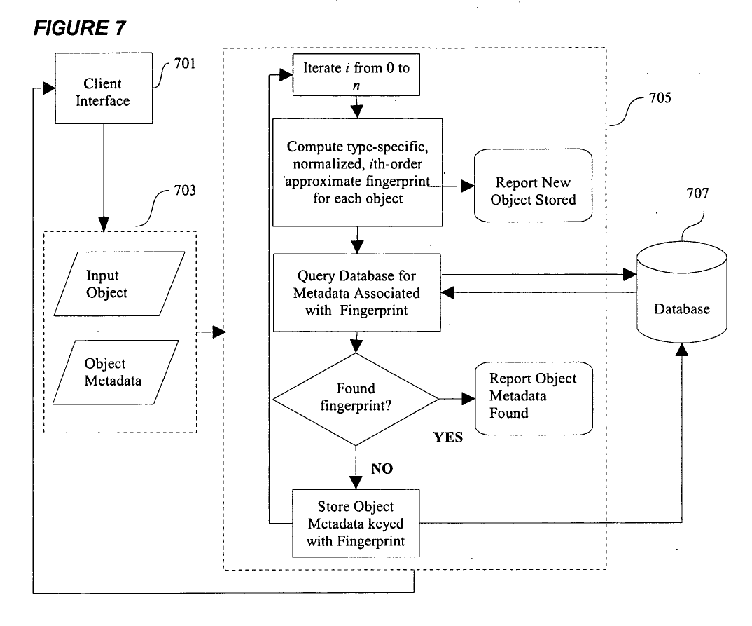

FIG. 7 is a block diagram showing a fingerprint generation and verification system according to an embodiment. As shown in the figure, this system is comprised of a client interface 701 that is used to select or input a digital object and associated metadata 703; a computational system 705 that interacts with the interface, and performs the iterative fingerprint generation method described in FIG. 6, with the modification that rather than compare directly with a second digital objects, the results are stored to and compared with past computation results in a database 707.

[Fifth Embodiment]

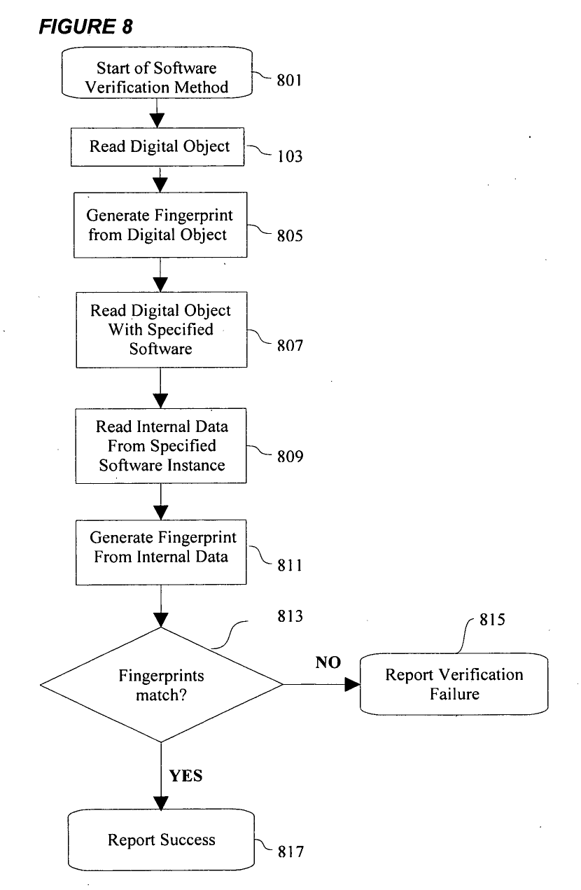

FIG. 8 is a flow chart showing a process to verify that a specified software program has correctly interpreted a specified digital object. As shown in the figure, the software verification method is comprised of the following steps: reading the into the specified software program's internal storage 103; generating a first numeric fingerprint from the object 805, in accordance with the method described in the first embodiment; reading the digital object with specified software 807; reading the internal data of that software 809; generating a fingerprint from that internal data 811 in accordance with the method described in the first embodiment; checking that the fingerprints match 813; and report failure 815 or success 817.

### CONCLUSION, RAMIFICATIONS, AND SCOPE

Accordingly the reader will see that, according to the invention, I have provided a method that can be used to verify that the semantic content of a digital object has not been altered by reformatting, even where the formatting causes loss of accuacy. In addition, I have provided a method that can be used to compare two different digital objects to determine whether, and to what degree of approximation, the semantic content of two digital object is the same. In addition I have provided an apparatus that can verify whether a software program has correctly interpreted the semantic content of a given digital object.

The methods, processes, and systems described above may be implemented in hardware, software, firmware, or a combination thereof. For example, the fingerprint generation process may be implemented in a programmable computer or a special purpose digital circuit. The methods and processes described above may be implemented in programs executed from a system's memory (a computer readable medium, such as an electronic, optical or magnetic storage device).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Thus the scope of the invention should be determined by the appended claims and their legal equivalents, and not by the examples given.

Having thus described the invention, what is desired to be protected by Letters Patent is presented in the subsequently appended claims.

What is claimed is:

1. A digital object verification method comprising:
an approximation process step of generating an approximation of the semantic content of a digital object;
a normalization process step of converting said approximation into a standard serialized normal form; and
a numeric hash process generating step of creating a numeric fingerprint from said serialized normal form.
Whereby, said method identifies the approximate semantic content of the object, does not require modification of the object content, and is robust to changes in the format of the object, even when such change causes losses in accuracy, precision, or quality.

2. The digital object verification method in accordance with claim 1, wherein said process step of generating a semantic approximation of a digital object comprises an approximation process step with a parameterizable degree of approximation.

3. The digital object verification method in accordance with claim 1, wherein said numeric fingerprint process generating step of creating comprises a cryptographic hash function.

4. The digital object verification method in accordance with claim 4, further comprising: a process step of encoding the hash in a self-documenting, printable, human-readable format.

5. A digital object comparison apparatus comprising:
means for generating a semantic approximation of the digital object;
means for generating data in serialized normal form, based on the output of said semantic approximation means;
means for generating a numeric fingerprint, based on the output of said serialized normal form means;
means for querying a database for existing fingerprints values that match the output of said numeric fingerprint means; and
means for storing numeric fingerprints in said database, based on the output of said numeric fingerprint means.
Whereby, it can be determined the degree to which two digital objects are approximately equal in semantic content.

6. A method to verify that a specified software program has correctly interpreted the approximate semantic content of a digital object, comprising:
A process step of generating a first numeric fingerprint from the object in accordance with the method described in claim 1;
A process step of reading said object into a software program's internal storage;
A process step of generating a second numeric fingerprint based on the contents of said internal storage;
A process step of comparing said first and second numeric fingerprints.
Whereby, said software program will be verified to have interpreted said digital object correctly.
